(19) United States
(12) Patent Application Publication
(10) Pub. No.: US 2014/0244006 A1
(43) Pub. Date: Aug. 28, 2014

(54) APPARATUS AND METHOD FOR MONITORING THE OPERATING STATUSES OF FACILITIES ON THE BASIS OF GRAPHICAL SECTOR REPRESENTATION

(71) Applicant: Seung-Chul Lee, Gyeonggi-do (KR)

(72) Inventor: Seung-Chul Lee, Gyeonggi-do (KR)

(21) Appl. No.: 13/914,136

(22) Filed: Jun. 10, 2013

(30) Foreign Application Priority Data
Feb. 28, 2013 (JP) 2013-040045

(51) Int. Cl. G05B 19/048

(52) U.S. Cl. CPC G05B 19/048
USPC 700/83

(57) ABSTRACT

An apparatus and a method for monitoring the operating statuses of facilities on the basis of graphical sector representation, which represent the operating status of facilities such as a plant or a building in a fan-shaped graphical representation in which sectors on a concentric circle are represented using the size of radius, different colors, and color tones. A data collection unit collects information and data required for monitoring the operating statuses of plurality of facilities. An operating status-determining unit determines the operating statuses of the facilities using the information and data transmitted from the data collection unit. A user interface unit divides a chart shaped as a concentric circle into sectors corresponding to various operating statuses of the facilities to be monitored, and represents each operating status of the facilities in a fan-shaped graphical representation extending from the center of a concentric circle serving as an origin.

### CROSS-REFERENCE TO RELATED APPLICATION(S)

This application claims priority to Japanese Patent Application JP 2013-040045 with a filing date of Feb. 28, 2013, which is incorporated herein by reference.

### FIELD OF THE INVENTION

The present invention relates to apparatus and method monitoring operating status of plant and building facilities, and more particularly to expressing the facility operating states using sector graphs in a concentric circle chart with colors and tones representing different operating statuses.

### BACKGROUND OF ART

Power plants, chemical processing plants, various manufacturing plants are normally composed of a number of subsystems, and each subsystem is again composed of numerous detailed subsystems and unit machines. For examples, a thermal power plants is normally composed of a turbine and auxiliary system, a boiler and auxiliary system, a main feed water system, a condensate system, a fuel supply system, a cooling water system, a circulating water system, an auxiliary steam system, etc. A turbine and auxiliary system is again composed of several detailed subsystems and/or unit machines such as a high pressure turbine, a medium pressure turbine, a low pressure turbine, a main steam valve system, a main stop valve system, a turbine speed control system, a turbine extraction steam system, a bearing lubrication system, etc. And again each of these subsystems is composed of further detailed subsystems and/or unit machines. Then the final product, electricity, can be produced through integrated operations of these facilities.

Therefore, to produce desired products in a plant, the operating states of the subsystems and machines should be monitored continuously in real time. If any of the operating state exceed the boundary of normal operating state, alarms should be given or plant can even be tripped depending on the severity of abnormality.

In case of large architectures like buildings, public facilities and apartment complexes, normally numerous supporting facilities such as mechanical system, electrical system, HVAC system, water supply system, fire fighting system, communication and networking system, elevator system, parking management system, security system, lighting control system, etc. are installed. Again each of these facilities is composed of numerous subsystems. To maintain the architectures in comfortable and yet optimal management conditions, all these facilities should be monitored continuously.

Facilities in plants and buildings have been monitored with the GUIs offered by the system suppliers or manufacturers.

The majority of the GUIs are composed of structural block diagrams, and/or functional flow diagrams displayed on monitors. Important parameters to be monitored are expressed using numerical indicators and/or bar type or line type graphs. If the values of the parameters exceed the boundaries of normal expected or setting values, indicators and/or graphs blink and/or change their colors, and explanations are provided using texts.

To monitor all the facilities and operate them safely, many monitor screens should be watched closely and significant manpower is required, and possibilities of human errors still exist all the time.

Furthermore, since the alarms are given only when operating states are significant, it is often too difficult to take adequate correction measures within appropriate times.

### SUMMARY OF THE INVENTION

The present invention is intended to solve problems and alleviate difficulties explained in the above BACKGROUND. The major objective of present invention is to offer an apparatus and a method for monitoring the operating statuses of facilities on the basis of graphical sector representation, which represent the operating status of facilities such as a plant or a building in a fan-shaped graphical representation in which sectors on a concentric circle are represented using the size of radius, different colors, and color tones. According to the present invention, the operating statuses of facilities to be monitored can be quickly and clearly checked at a glance, thereby improving the ability to monitor the operating status of facilities, reducing manpower, and improving the accuracy and efficiency of monitoring.

An additional objective is to offer an apparatus and a method that can give early warnings such that operators can take proper corrective actions within appropriate time in case when operating states approach abnormal states.

Another objective is to enable operators of facilities quickly perceive the progress status a trip logics when two or more conditions are combined in the trip logic.

The apparatus of present invention is composed of a data collecting unit configured to collect information and data for monitoring plant and building facilities, and a status determining unit of said facilities using the information and data from said data collecting unit, and a user interface unit configured to divide a concentric chart into sectors corresponding to monitoring facilities and to express operating status of each of facilities into a fan-shaped sector graph, which has the center of said concentric chart as its origin.

And said concentric chart is divided into sectors corresponding to monitoring facilities and to express operating state of each of facilities into a fan-shaped sector graph. The operating states are distinguished as Normal Stop State, Normal Operating State, Alert Operating State, Emergency Operating State, Emergency Stop (Trip) State, and expressed with different colors and tones. The radius of the sector graph for Normal Stop State corresponds to 0.

And said concentric chart is composed of major thick radius scales representing the major categories of the facility operating statues and minor thin radius scales in-between the major scales representing the furthered detailed operating status of each facility.

And the color of each sector graph is changed into gradually darker tones towards the end of graph if the operating state of corresponding monitored facility or measurement value is continuously being aggravated, and into gradually thinner tones towards the end of graph if operating state of corresponding monitored facility or measurement value is continuously being improved.

And If the operating state swings between two operating states, the portions of sector graph corresponding to those two operating states are expressed with a darker tone.

If two or more monitoring items are bound with a trip logic, trip stripe is used together with sector graph such that the progress status of trip condition can be quickly observed.

Sector graph based facility operating status monitoring apparatus expresses the facility operating statuses with said sector graphs using such data and information as structure of facilities, reference values for assessing operating states, information and data collection intervals and input methods, required number of concentric circles and radius scales, and content of each sector representation from databases, knowledge-bases and/or through GUIs.

In addition, sector graph based facility operating status monitoring method comprises (a) a stage of collecting information and data by a user interface unit to assess operating states, (b) a stage of assessing operating states of facilities using said information and data by a status determining unit, and (c) a stage of dividing a concentric chart into sectors corresponding to monitoring facilities and to express operating status of each of facilities into a fan-shaped sector graph having the center of said concentric chart as its origin, wherein sectors can further be divided into minor sectors depending on numbers of monitoring facilities or measurement values, and radius of a sector graph grows as the operating state of corresponding facility or measurement value digresses from normal operating state or normal measurement value by a user interface unit.

The expected effects of the present invention are as follows: The facility monitoring manpower and human errors can be reduced, and the accuracy and speed of the monitoring tasks can be improved since the operating statuses of plant and building facilities can be densely and visually represented using sector graphs and colors such that entire operating states can be perceived at a glance. For example, if 3° is allocated to each sector, a total of 120 items can be monitored with a single chart. In addition, the number of monitoring items can be increased freely since the monitoring charts are composed hierarchically. The main upper level chart represents only the representative severe states chosen in each of the lower level chart. By looking at the main chart only, the operating states of the entire facilities in plants or in buildings can be monitored.

Furthermore, since each sector graph is expressed such that the tone of the color of sector graph is changed into gradually darker tones towards the end of sector graph if operating state of corresponding monitoring facility or measurement values is continuously being aggravated, and into gradually thinner tones towards the end of sector graph if operating state of corresponding monitored facility is continuously being improved. If the operating state swings between two operating states, the portions of the sector graph corresponding to those two operating states are expressed with a darker tone.

In addition, since the past operating states and faults can be easily traced with concentric charts showing the operating states of past time intervals when faults are propagated, plant trips and consequent large economical losses can be reduced.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is block diagram of apparatus for monitoring the operating statuses of facilities.

FIG. 2 is an exemplary facility operating state monitoring chart applied to a plant.

FIG. 3 is a detailed drawing providing explanations for FIG. 2.

FIG. 4 is an example of state distinctions used in FIG. 2.

FIG. 5 shows examples of sectors grouped with m out of n type trip logics.

FIG. 6 is a drawing for explanation of 4 out of 60 trip logic progressing states.

FIG. 7 is shows 4 sectors in the main chart and their trip stripes representing 60 sectors in the lower chart. The colors of the trip stripes of the 4 sectors change in unison showing that 4 sectors are bound with same trip logic. The colors of the trip stripes change in steps as the monitoring items meeting the trip conditions are increased.

FIG. 8 is an exemplary block diagram of present invention applied to a building.

FIG. 9 is an exemplary facility operating state monitoring chart applied to a building.

FIG. 10 is a flow diagram of present invention for monitoring building operating status.

### DETAILED DESCRIPTION

The present invention, Apparatus and Method for Monitoring the Operating Statuses of Facilities on the basis of Graphical Sector Representation, will be described herein referring the attached drawings using a detailed example.

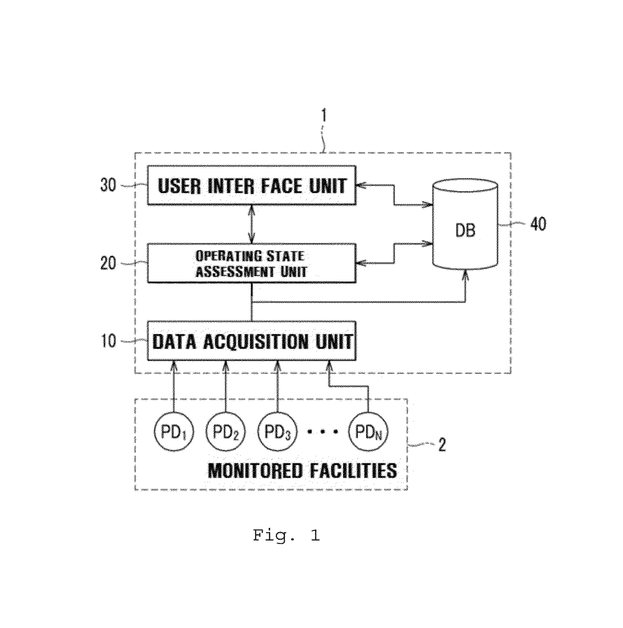

FIG. 1 is block diagram of apparatus for monitoring the operating statuses of facilities.

As shown in FIG. 1, the facility operating status monitoring apparatus based on sector graph (1) is compose of a data acquisition unit(10) collecting operational parameter data and information (PD1˜PDn) from subsystems of the monitored plant(2) and storing operational data and information in database(40), and an operating state assessment unit(20) assessing the operating states of subsystems and storing the results in the database(40), a user interface unit(30) expressing the operating status of each of facilities into a fan-shaped sector graph, which has the center of said concentric chart as its origin. The user interface unit(30) can show the past charts or the lower level charts according to the requests from the users, and receive inputs such as the setting values of the alarms and trips from the user and store those information in the database(40).

Referring to FIG. 1, the monitored facilities(2) can be power plants, chemical processing plants, buildings, etc. having a number of subsystems, and the data and information (PD1˜PDn) represent the analog measurement values and alarm and trip limit switch values.

The user interface unit(30) expresses the operating states of subsystems assessed by the operating state assessment unit(20) in the monitoring chart, wherein the monitoring chart is composed of a concentric chart, sector name plates, trend windows, and a text window. In addition, the user interface unit(30) facilitates tracing the propagation status and the cause of a fault by showing a series of past concentric charts in time sequence.

Thus, the present invention, the operating status monitoring apparatus(1) expresses the statuses of analog and binary measurement values related to alarms and trips using densely placed sector graphs in a concentric chart such that the measurement values can be quickly observed.

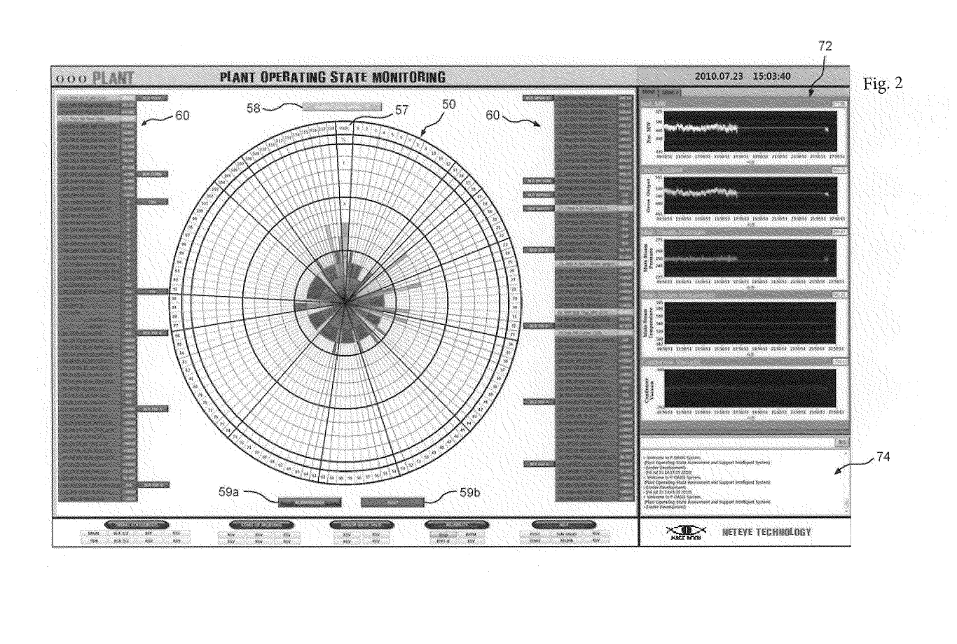

FIG. 2 is an exemplary display showing the operating statuses of subsystems and is composed of a concentric chart(50), sector name plates(60), trend display windows(72), and a text explanation window(74).

The concentric chart(50) shows the statuses and the trends of analog and binary measurement values related to alarms and trips, and shows the progress statuses of trip logics composed of various analog measurement values and limit switch signals. Wherein the alarm status is an abnormal state digressed from normal operating state and the trip status is a state that the apparatus must be stopped to avoid serious damage or to prevent propagations of faults.

Referring to FIG. 2, the concentric chart(50) is composed of concentric circles and sectors. The number of sectors can be adjusted by the angle allocated to each sector. In FIG. 2, a total of 120 sectors are accommodated in a chart by allocating 3° to each sector. In addition, the concentric chart(50) is organized with major concentric circles showing the boundaries among the operating states such as Normal, Alert, Alarm, Emergency, Extreme, etc. and with minor concentric circles in-between the major concentric circles expressing the varying degrees of severities within each operating state.

In addition, the concentric charts50) are organized with a hierarchy such that lower level charts show the statuses of detailed and specific measurement values and higher level chart shows the integrated results or the summaries of multiple sectors of lower level charts. Therefore, number of monitoring items can be freely increased by increasing the number of lower level charts yet the operating statuses of the entire facility can be monitored by observing the main summary chart.

FIG. 3 shows an exemplary organization of the concentric chart.

The concentric chart is composed of sector graphs(51), trip stripe(52), sector number stripe(53), and sector name plates(60) placed on both sides of the chart.

Each sector graph(51) is fan-shaped, and has scales representing the boundaries among the major and the minor detailed state. The scales can be proportional or log or combinations both depending on the expression needs of monitoring items. For example, the states in FIG. 3 can be summarized as shown in Table 1.

TABLE 1

| | Detailed | | |
|---|---|---|---|
| Main State | State | Scale No. | Remarks |
| Normal State | NL | 1 | Green |
| | N | 2 | |
| | NH | 3 | |
| | NHH | 4 | |
| Alert State | AL | 5 | Orange |
| | A | 6 | |
| | AH | 7 | |
| | AHH | 8 | |
| Emergency | EL | 9 | Red |
| state | E | 10 | |
| | EH | 11 | |
| | EHH | 12 | |
| Trip State | TS | Trip Stripe | Purple |

First, the Normal State(N) is a state that the assessed status or the measurement values of monitoring item is within its normal operating range. The Normal state is expressed with Green color and further divided into 4 detailed states such as NL (Normal Low), N(Normal), NH (Normal High), and NHH(Normal High High). Second, the Alert State(N) is a state that the assessed status or the measurement values of monitoring item approaches alarm set value. The Alert state is expressed with Orange color and further divided into 4 detailed states such as AL (Alert Low), A(Alert), AH (Alert High), and AHH(Alert High High). Third, the Emergency State(N) is a state that the assessed status or the measurement values of monitoring item exceeds the alarm set value and approaches trip set value. The Emergency state is expressed with Red color and further divided into 4 detailed states such as EL (Emergency Low), E(Emergency), EH (Emergency High), and EHH(Emergency High High). Fourth, the Trip State(TS) is a state that the assessed status or the measurement values of monitoring item exceeds the trip set value. In case of Trip State, entire sector graph is filled with Purple.

Therefore, in this exemplary case, the sector graph has a total of 12 scales, which can be adjusted depending on the needed precision levels of the assessed states.

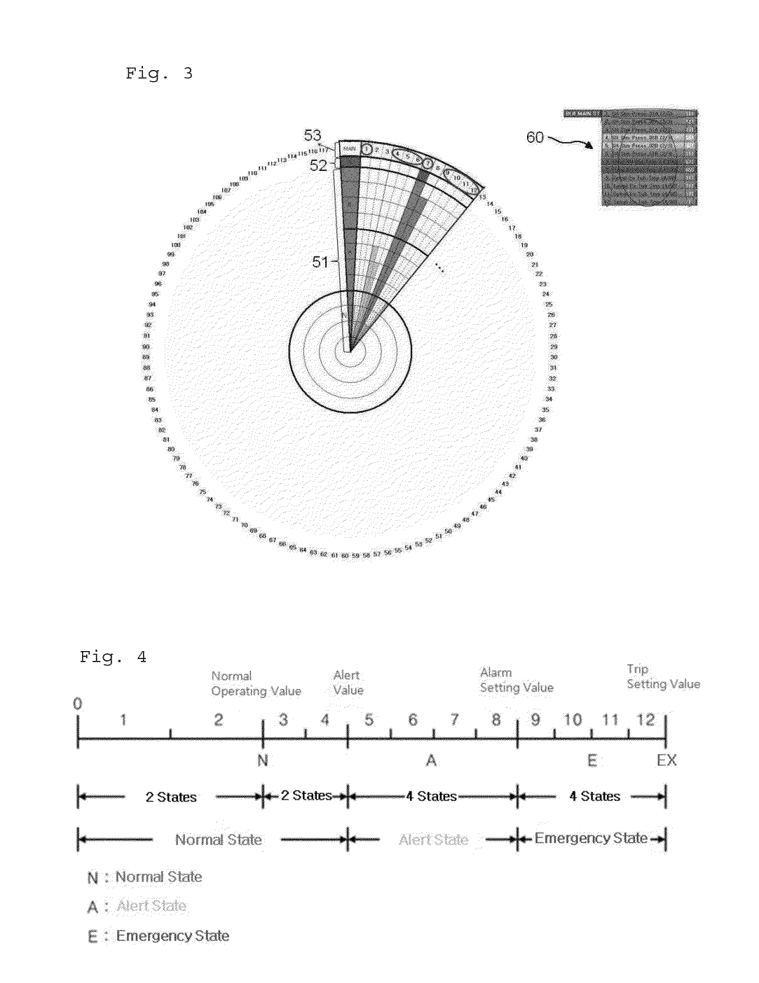

FIG. 4 shows an exemplary way of deciding the boundaries of each state. Initially four values such as normal, alert, alarm, and trip are given, which are used as the boundaries among main states.

The normal value is used as scale No. 2, the alert value as scale No. 4, the alarm value as scale No. 8, and the trip value as scale No. 12. Then the minor scale numbers can be decided by equally dividing the differences among the main boundary values as shown in FIG. 4.

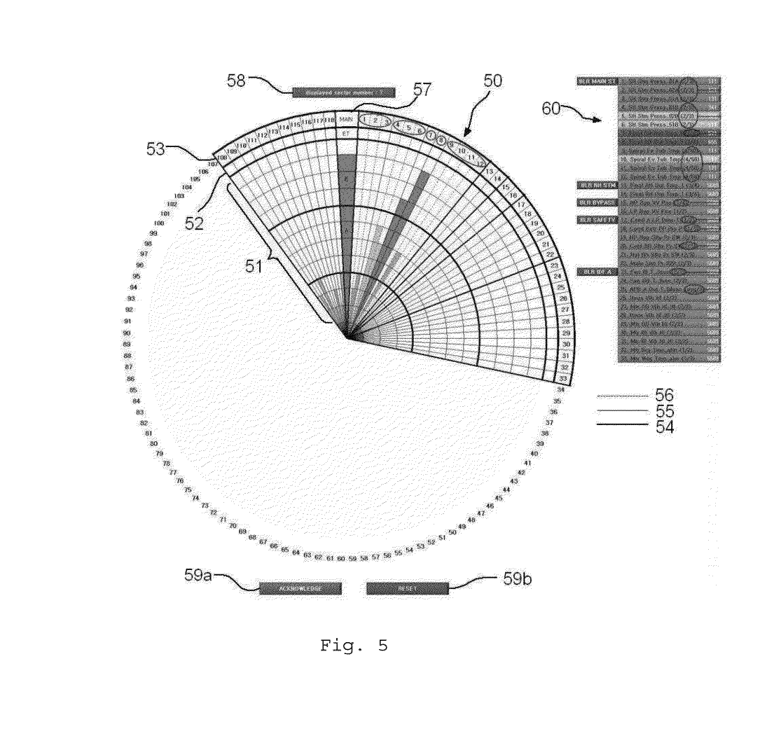

FIG. 5 shows an exemplary way of grouping sectors into main groups and detailed groups. Sectors belonging to a subsystem can be grouped as one of main group, while sectors bound with a specific trip logic can be grouped as a minor group inside the main group.

In FIG. 5, the boundary between two main groups is expressed with a thick line, while the boundary between two minor groups is expressed with a thin line . The boundaries among the sectors belonging to a minor group are expressed with dotted lines. And the boundaries among independent sectors are expressed with thin lines.

FIG. 5 shows that the sectors numbered from 1 to 12 are bound as a main group, and that the main group is composed of 3 minor groups and two independent sectors as shown in Table 2.

TABLE 2

| | Sector Name Plates | | | |
|---|---|---|---|---|
| Sector | Sector Name | Measurement | | Main |
| No. | (Trip Logic) | Value | Minor Group | Group |
| 1 | SH Stm | *** | A | BLR |
| | Press_01A(2/3) | | | MAIN |
| 2 | SH Stm | *** | | ST |
| | Press_02A(2/3) | | | |
| 3 | SH Stm | *** | | |
| | Press_51A(2/3) | | | |
| 4 | SH Stm | *** | B | |
| | Press_01B(2/3) | | | |
| 5 | SH Stm | *** | | |
| | Press_02B(2/3) | | | |
| 6 | SH Stm | *** | | |
| | Press_51B(2/3) | | | |
| 7 | Final SH Out | *** | Independent | |
| | Tmp_1(3/4) | | Sector | |
| 8 | Final SH Out | *** | Independent | |
| | Tmp_2(3/4) | | Sector | |
| 9 | Sprial Ev Tub | *** | C | |
| | Tmp(4/60) | | | |
| 10 | Sprial Ev Tub | *** | | |
| | Tmp(4/60) | | | |
| 11 | Sprial Ev Tub | *** | | |
| | Tmp(4/60) | | | |
| 12 | Sprial Ev Tub | *** | | |
| | Tmp(4/60) | | | |

In Table 2, the main group BLR MAIN ST(Boiler Main Steam) is composed of 12 sectors, and the minor group A is composed of sectors 1,2 and 3, and the minor group B of sectors 4, 5, and 6 with dotted boundary lines among them.

In the sector name plates(60), expression “m/n” implies the corresponding sector belongs to an m out of n type of majority voting logic. In the lower level chart, n sectors are allocated to express the logic, while m sectors are allocated in the upper level main chart.

For example, 4/60 implies that 60 sectors are used in the lower level chart and 4 sectors are allocated in the upper main chart. Only the most severe 4 states, equally 4 sectors, are expressed in the main chart as representatives.

In case when m equals 1 in ‘m/n’ expression, it implies that n sectors in the lower level chart are represented with one sector in the upper level main chart for sector representation efficiency showing those sectors are not related with any trip logic.

If one of trip conditions in a m/n trip logic is met, the color of the trip stripe belonging to that n sectors change together. The color shows the proximity to the corresponding trip condition. Table 3 shows an example of color allocation for trip stripes.

TABLE 3

| No. of Trip Condition Met | |
|---|---|
| in m/n Trip Logic | Color of Trip Stripe |
| Trip Confirmed | Rurple |
| Trip condition met (m) | Red |
| One more condition to trip (m-1) | Pink |
| two more condition to trip (m-2) | Orange |
| three more condition to trip (m-3) | Yellow |

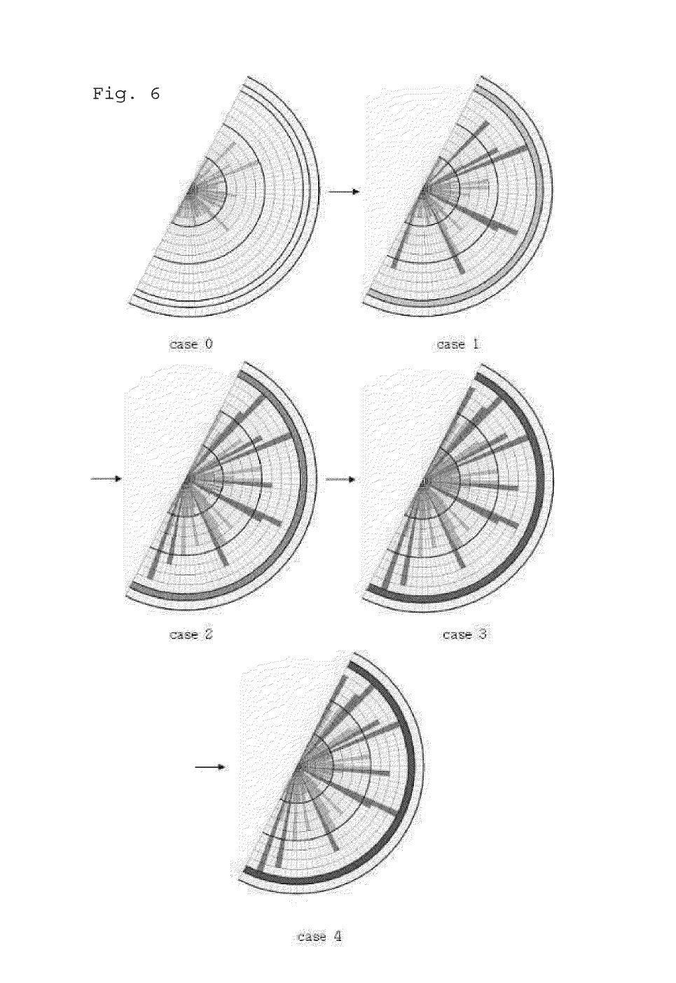

FIG. 6 shows the color changes of the trip stripes according to Table 3 as the operating state approaches the trip condition in 4/60 trip logic.

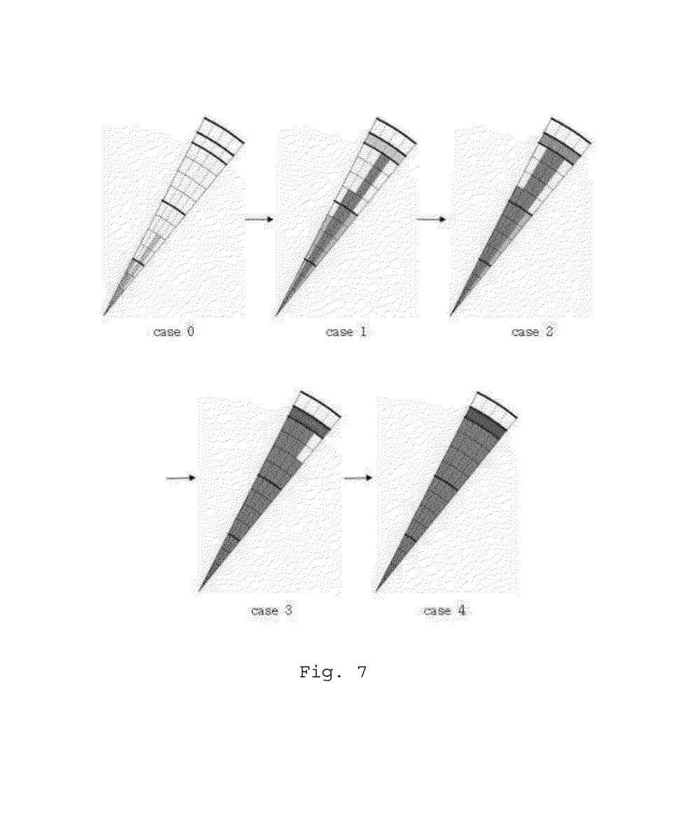

FIG. 7. Shows above 4/60 logic expressed with 4 sectors in the upper main chart, and color changes of the stripe are identical with those in FIG. 6.

In case when binary limit switch values are used in addition to analog measurement values, main state boundary changes may be confirmed by the binary limit switch value, while detailed states in-between main boundaries may be decided by the analog values.

If only binary limit switch values are used, the corresponding sector graph may have only 3 states such as Normal, Emergency and Trip states with the graph length of 2, 8 and 12 respectively.

If the operating state corresponding to a specific sector drifts, the tone of the color toward the end of the sector graph is changed. If the state is being aggravated, the tone becomes darker. If the state is being improved, the tone is changed into a lighter tone. If the state swings between two states, the section of the graph corresponding to two states is expressed with same darker tone, where the darkness depends on the severity of the swing.

In case when time delay is involved after a trip condition is met, the color of the trip stripe may be expressed with Brown, which changes into Red or Purple when the delay time is passed.

Referring to FIG. 2, a sector name plate is allocated to each sector and is displayed on both sides of the chart. The sector name plate includes the sector number, the sector name, and additional numbers showing trip logic, mapping sector numbers between upper and lower charts or the measurement or the assessment values.

The color of the name plate changes together with that of the corresponding sector graph to identify the sector graphs changing colors instantly.

When a name plate or corresponding sector is clicked, corresponding trend window and/or lower level chart appears as appropriate.

If a monitored item has an alarm only, the expression “-alm” is attached at the end of the name. If multiple number of measurement values are used, number of values used is attached at the end of the name too.

The expression “1/n” is attached at the end of a name if the corresponding item is a member of group of n sectors, and only one sector is allocated in the upper level main chart. Only the sector with the most severe state is shown in the upper main chart, and an explanation is provided in the text window(74) shown in FIG. 2.

In FIG. 2, the main sector is a sector located at the upper middle sector of a chart. The main sector represents the most severe state among all the sectors in the chart. With the same token, sector with the most severe state is expressed repeatedly in the main sector.

If an alarm or a trip condition is met, the corresponding sector graph and name plate blink together until they are acknowledged.

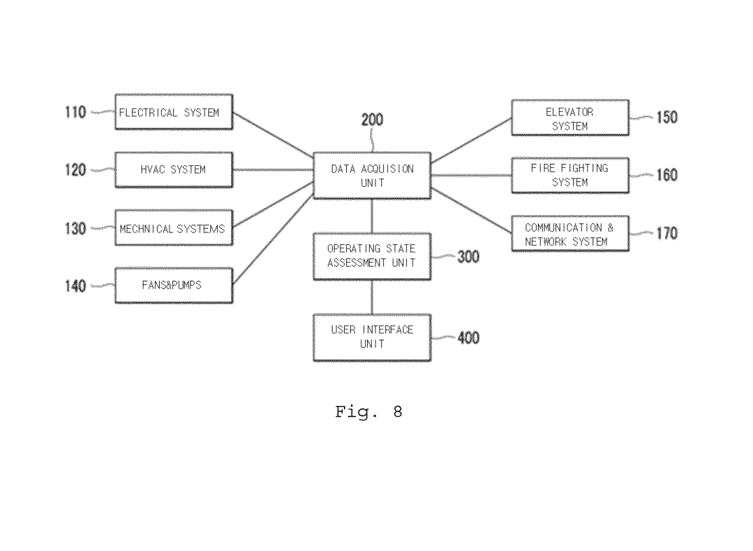

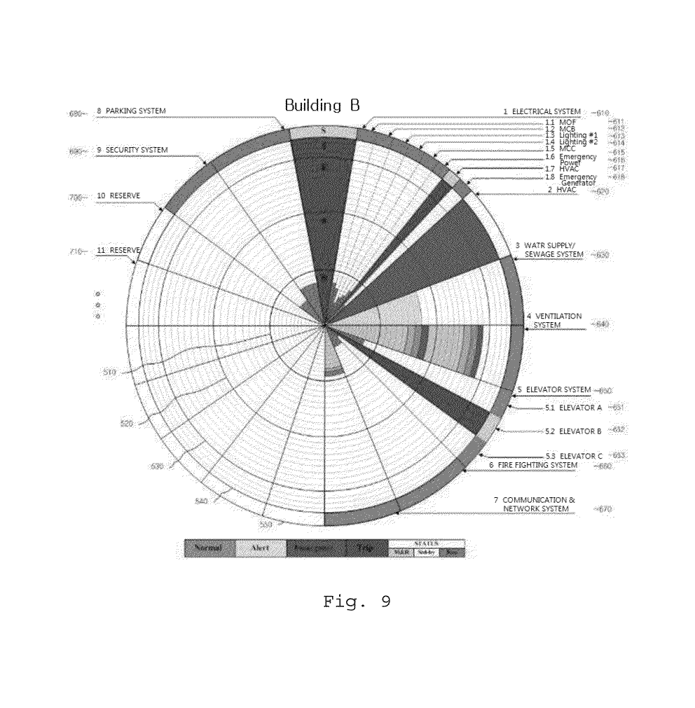

FIG. 8 shows an exemplary way of applying the present invention to a building.

As shown in FIG. 8, monitored facilities include an electrical system(110), a HVAC system(120), a mechanical system(130), fans & pumps(140), elevator system(150), fire fighting system(160), and a communication and network system(170). Other facilities can be included depending on particular applications.

The data acquisition unit(200) collects information and data needed for monitoring the facilities(110˜170). The collected information and data are transferred to the operating state assessment unit(300), where the facility operating states are assessed.

The user interface unit(400) shows the sector graphs in the concentric charts based on the state assessment results received from the operating state assessment unit(300).

The concentric charts can be organized with a hierarchy as needed to accommodate all the detailed facilities composing main facilities(110˜170).

From here and below, the concentric chart used for monitoring building facilities will be called as FAST (Facility Availability Status Tracking Chart) chart, and the concentric chart used for monitoring plant facilities will be called as POST (Plant Operating Status Tracking Chart) chart.

FIG. 9 is an exemplary FAST chart showing the operating states of a building.

Each sector represents major facility of the building, and can further be divided into several sectors. The sectors can be allocated with the same angles or with different angles for convenience.

As explained in the POST chart, the radius of a sector graph grows as the operating state digresses from the normal operating state.

The main concentric circle with the shortest radius(510) represents the Normal Operating State, and next main circle(520) represents the Alert Operating State. Third main circle(540) and the fourth main circle represent the Emergency Operating State and the Emergency Trip State respectively. In case of FAST chart, the trip stripe(550) are utilized for other purposes such as the availabilities or the detailed operating states of facilities if trip logics are not implemented.

For example, the trip stripe(550) can represent facility states such as a Maintenance and Repair State, a Stand-by State, Start-up State, Full-Operation State, Partially Operating state, and Shut-down State.

Arrows also can be used instead of name plates. Color representations for sector graphs are identical with those in POST chart.

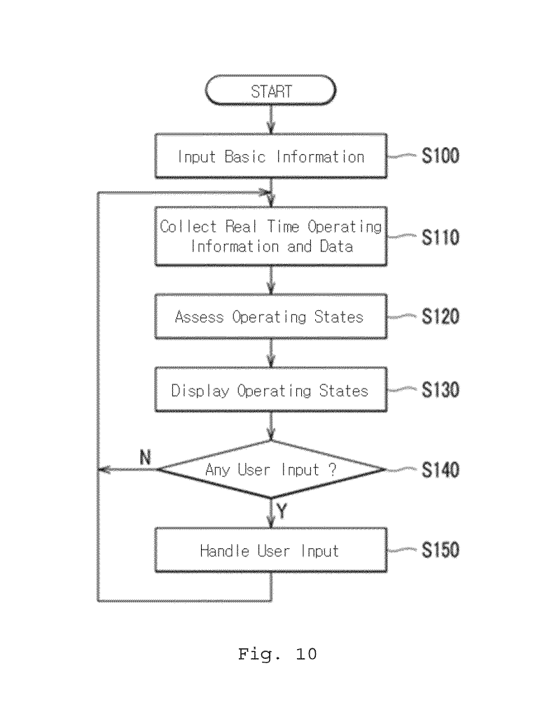

FIG. 10 shows the flow diagram for facility operating status monitoring method of the present invention.

As shown in FIG. 10, a sector graph based facility operating status monitoring method starts with a stage of collecting basic information and data by a user interface unit need to assess operating states(S100). In the next stage, real time operational data are collected in regular intervals(S110), and the operating states of facilities are assessed using the collected data(S120) by a status determining unit(120), and the assessment results are displayed(S130) using the POST or the POST charts.

The present invention, the facility operating status monitoring apparatus, can be implemented using multiple servers organized hierarchically as the amount of information to be processed increase. The software is implemented as a multi-agent system using processes and/or threads.

In the next stage, Existence of any user input is checked(S140). If an input is detected, it is processed. Otherwise, flow returns to the Stage S110 and the process is repeated in a loop.

If the user input is the request of tracing the sequence of event(SOE), the user interface unit shows a series of past charts with sliced time intervals to facilitate fault tracing if operating states progressed into aggravated or abnormal states. Each chart can be expanded if it is clicked.

According to the present invention, an apparatus and a method for monitoring the operating statuses of facilities on the basis of graphical sector representation, the operating status of facilities such as a plant or a building are expressed with sectors on a concentric circles with distinctive radius and colors. Thus the operating statuses of facilities can be checked quickly and clearly at a glance, thereby improving the ability monitoring, reducing manpower, and reduce the chances of human errors. The additional advantage of the present invention is it can give early warnings such that operators can take proper corrective actions within appropriate time in case when operating states approach abnormal states.

The embodiments that have been described herein, however, are but some of the several which utilize this invention and are set forth here by way of illustration but not of limitation For example, various features and advantages described herein may be combined or used separately. It is obvious that many other embodiments, which will be readily apparent to those skilled in the art, may be made without departing materially from the spirit and scope of the invention.

What is claimed is:

1. A sector graph based facility operating status monitoring apparatus comprising:
a data acquisition unit configured to collect information and data for monitoring plant and building facilities;
a status determining unit of said facilities using the information and data from said data collecting unit; and
a user interface unit configured to divide a concentric chart into sectors corresponding to monitoring facilities and to express operating status of each of facilities into a fan-shaped sector graph, wherein the fan-shaped sector graph has the center of said concentric chart as its origin.

2. The sector graph based facility operating status monitoring apparatus of claim 1, wherein said concentric chart expresses the facility operating statuses using scales represented with different radiuses of said concentric charts sharing the same origin, wherein such scales are composed of major scales representing the major categories of the facility operating statues and minor scales in-between the major scales representing the furthered detailed operating status of each facility.

3. The sector graph based facility operating status monitoring apparatus of claim 1, wherein said concentric chart is configured to distinguish each facility operating status as Normal Stop State, Normal Operating State, Alert Operating State, Emergency Operating State, Emergency Stop(Trip) State, and expresses each operating state using different color.

4. The sector graph based facility operating status monitoring apparatus of claim 1, wherein the tone of the color of each sector graph is changed into gradually darker tones towards the end of said sector graph if the operating state of corresponding monitored facility or measurement value is continuously being aggravated, and into gradually thinner tones towards the end of sector graph if operating state of corresponding monitored facility or measurement value is continuously being improved, and if the operating state swings between two operating states, the portions of sector graph corresponding to those two operating states are expressed with the same darker tone.

5. The sector graph based facility operating status monitoring apparatus of claim 1, wherein said concentric chart is configured to organize said sectors belonging to the same trip logic into a group and to express the progressiveness of the trip logic using the colors of the trip stripes belonging to the sectors of the same trip logic.

6. The sector graph based facility operating status monitoring apparatus of claim 1, wherein said user interface unit is configured to show nameplate corresponding to each sector graph, wherein said name plate expresses sector number, sector name, trip condition and real time measurement value.

7. The sector graph based facility operating status monitoring apparatus of claim 1, wherein said user interface unit is configured to show trends of measurement values if a sector or corresponding name plate is clicked and if said sector represent a status of a measurement value, or to show lower level concentric chart showing detailed status related to said sector if said sector shows representative or integrated status of multiple sectors of said lower level concentric chart in chart hierarchy.

8. The sector graph based facility operating status monitoring apparatus of claim 1, wherein said user interface unit is configured to show a series of past charts with sliced time intervals to facilitate fault tracing if operating states progressed into aggravated or abnormal states.

9. A sector graph based facility operating status monitoring method comprising:
(a) collecting information and data by a user interface unit to assess operating states;
(b) assessing operating states of facilities using said information and data by a status determining unit; and
(c) dividing a concentric chart into sectors corresponding to monitoring facilities and to express operating status of each of facilities into a fan-shaped sector graph having the center of said concentric chart as its origin, wherein sectors are further divisible into minor sectors depending on numbers of monitoring facilities or measurement values, and radius of a sector graph grows as the operating state of corresponding facility or measurement value digresses from normal operating state or normal measurement value by a user interface unit.

10. The sector graph based facility operating status monitoring method of claim 9, wherein said concentric chart expresses facility operating statuses using scales represented with different radiuses of said concentric charts sharing the same origin, wherein such scales are composed of major scales representing major categories of facility operating status and minor scales in-between the major scales representing the furthered detailed operating status of each facility.

11. The sector graph based facility operating status monitoring method of claim 9, wherein said concentric chart distinguishes each facility operating status as Normal Stop State, Normal Operating State, Alert Operating State, Emergency Operating State, Emergency Stop(Trip) State, and expresses each operating state using different color.

12. The sector graph based facility operating status monitoring method of claim 9, wherein said sector graph is expressed such that the tone of the color of each sector graph is changed into gradually darker tones towards the end of sector graph if operating state of corresponding monitoring facility or measurement values is continuously being aggravated, and into gradually thinner tones towards the end of sector graph if operating state of corresponding monitored facility is continuously being improved, and if the operating state swings between two operating states, the portions of the sector graph corresponding to those two operating states are expressed with a single darker tone.

13. The sector graph based facility operating status monitoring method of claim 9, said concentric chart is organize such that sectors belonging to the same trip logic are grouped and the colors of the trip stripes belonging to the sectors of the same trip logic group change together based on the progressiveness of the trip logic.

14. The sector graph based facility operating status monitoring method of claim 9, wherein said dividing of said concentric chart into sectors further comprises showing nameplate corresponding to each sector graph, wherein said name plate expresses sector number, sector name, trip condition and real time measurement value.

15. The sector graph based facility operating status monitoring method of claim 9, wherein said dividing of said concentric chart into sectors further comprises monitoring facilities and to express operating status of each of facilities into a fan-shaped sector graph having the center of said concentric chart as its origin, wherein sectors are further divisible into minor sectors depending on numbers of monitoring facilities or measurement values, and radius of a sector graph grows as the operating state of corresponding facility or measurement value digresses from normal operating state or normal measurement value by a user interface unit.

16. The sector graph based facility operating status monitoring method of claim 9, wherein said dividing of said concentric chart into sectors further comprises showing a series of past charts with sliced time intervals to facilitate fault tracing if operating states progressed into aggravated or abnormal states.
